(19) United States
(12) Patent Application Publication
(10) Pub. No.: US 2004/0034665 A1
(43) Pub. Date: Feb. 19, 2004

(54) Extensible structured controlled vocabularies

(76) Inventor: Kenneth Haase, Dorchester, MA (US)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 10/463,116

(22) Filed: Jun. 17, 2003

Related U.S. Application Data
(60) Provisional application No. 60/389,184, filed on Jun. 17, 2002.

(51) Int. Cl. G06F 17/00

(52) U.S. Cl. 707/104.1

(57) ABSTRACT

The present invention relates to systems and methods for describing unstructured or semi-structured documents in a collection to improve the effectiveness of search, the quality of human browsing, and the automation of information handling processes. One embodiment of the invention provides methods for annotating documents and fragments of documents with terms from an Extensible Structured Controlled Vocabulary (ESCV). This vocabulary can be an artificial language whose terms are connected to one another by a fixed variety of relations and which can be used in expanding searches, presenting documents or sets of documents, or making decisions about document disposition. The vocabulary can also be extended with new terms but only by relating those new terms to existing terms in the vocabulary.

### CROSS REFERENCE TO RELATED APPLICATION

This document claims priority to, and the benefit of the filing date of, copending provisional application entitled “Fine Grained Document Description Using Extensible Structured Controlled Vocabularies,” assigned serial No. 60/389,184, filed Jun. 17, 2003, and which is hereby incorporated by reference in its entirety.

### BACKGROUND OF THE INVENTION

The present invention relates to methods and systems for describing unstructured or semi-structured documents in a collection to improve the effectiveness of search, the quality of human browsing, and the automation of information handling processes.

Controlled Vocabularies

For at least the past century, librarians and content creators dealing with conventional information resources (and more recently with digital information resources) have used controlled vocabularies of keywords to describe those resources. These controlled vocabularies make searching possible by providing a limited set of entry points to a document collection. These vocabularies include keywords (typically drawn from human languages), which are used in narrow and stylized ways to avoid the ambiguity of natural human language.

Today, even as literal free text searches of large document collections are easy and efficient, carefully thought-out keyword searches of annotation databases consistently yield better retrieval results on fixed collections than casually constructed keyword searches. Stated another way, document collections grow and this growth can require expansion of controlled vocabularies. Such expansion can become a source of problems.

On the one hand, if expansion is easy (if it is simple to add a new term to the controlled vocabulary), practitioners encounter the problem of idiosyncratic description. Here, new terms are added which are identical or close in intent with existing terms and resources annotated with the one term will not be accessible to searches using the other term. This problem can be particularly common in multi-person organizations where the extension of the vocabulary is not coordinated. The severity of the problem grows as the size and dispersal of the organization increases.

On the other hand, if expansion is too difficult (if adding a new term is practically difficult), content annotators will end up using the same term with different intents and purposes, leading to ambiguous description where very different documents are annotated with the same term from the controlled vocabulary.

In conventional information retrieval terms, the consequence of idiosyncratic description is reduced recall: relevant documents are missed; the consequence of ambiguous description is reduced precision: irrelevant documents are retrieved.

Human natural languages can be seen as an extreme case of both these problems, since local vocabulary expansion is very simple but global vocabulary expansion is extremely difficult. As a consequence, human natural languages are rife with both idiosyncrasy (many ways to say the same thing) and ambiguity (many meanings for the same word). Ironically, most modern information retrieval systems—especially for dynamic collections—rely on exactly such human-language based solutions, retrieving based on the natural language words in documents and queries.

In many cases, the practical solution to these problems is the informal limitation of controlled vocabularies to particular levels of description. By limiting new additions to a particular level of specificity, it is more likely that separate individuals will pick the same term to describe a particular concept or intention. The problem with this informal solution is that it limits the specificity of description. While this may be sufficient for moderate sized document collections or for searches to retrieve whole documents, it is problematic for very large and diverse document collections or for searches that retrieve individual fragments (for instance, paragraphs) of documents.

Structured Controlled Vocabularies

The use of structured controlled vocabularies (SCVs) resolves some of these problems. In a structured controlled vocabulary, also known as an ontology, there is a controlled set of artificial terms but various relations connect these terms to one another. These relations allow individual terms to be expanded to include terms with similar (broader or narrower) intention, allowing precision of description without sacrificing generality of recall. Experiments with large structured controlled vocabularies have shown that both recall and precision are improved by their utilization.

The problem with a controlled structured vocabulary is that annotation—because it involves interpretation and determination of meanings—is a labor-intensive process that is difficult to automate. This makes it impractical for large and growing document collections and especially for describing public information resources such as the World Wide Web.

Furthermore, existing SCVs typically have a fixed scope and size because the controlled vocabularies generally require uniqueness: distinct meanings must correspond to single terms in the vocabulary. This means that extending the vocabulary requires substantial linguistic or semantic expertise.

It is noteworthy that many existing web search engines use a degenerate form of structured controlled vocabularies in their web directories. In this case, a hierarchical set of categories is used to organize information content on the web, with placement into categories typically based on human judgment. This can be an extremely effective way to “make sense” of a large content pool such as the web, but suffers from two deficits: first, there is a single relation between terms in the vocabulary, and the semantics of this relationship are unclear second it is impossible for users of the service, e.g., those who add pages to the web, to extend the vocabulary.

SCVs are vocabularies, which improve precision and recall by relying on terms with unambiguous meanings (improving precision) while allowing for reliable expansion by authorized administrators through term-to-term relations (retaining and improving recall). Chief problems of SCVs are that annotation with an SCV is labor-intensive and that extension of an SCV requires special skills (typically linguistic or semantic expertise) so that most SCV's are fixed (though large) collections of terms. An example of an ontology or SCV is the WordNet on-line lexical thesaurus described in “Interlingual BRICO” by Kenneth Haase, IBM Systems Journal, Volume 39, NOS 3&4, 2000 and incorporated herein by reference in its entirety. WordNet uses synsets; a synset represents a meaning or word sense that may be named by more than one word. The synsets are related to one another. However, a need remains for a SCV that is extensible by non-expert users.

### SUMMARY OF THE INVENTION

The present invention relates to systems and methods for describing unstructured or semi-structured documents in a collection to improve the effectiveness of search, the quality of human browsing, and the automation of information handling processes.

One embodiment of the invention provides methods for annotating documents and fragments of documents with terms from an Extensible Structured Controlled Vocabulary (ESCV). This vocabulary can be an artificial language whose terms are connected to one another by a fixed variety of relations and which can be used in expanding searches, presenting documents or sets of documents, or making decisions about document disposition. The vocabulary can also be extended with new terms but only by relating those new terms to existing terms in the vocabulary.

### BRIEF DESCRIPTION OF THE DRAWING

FIG. 1 is a flow chart of the operation of one embodiment of an automated vocabulary generation system.

### DETAILED DESCRIPTION OF THE INVENTION

The present invention relates to systems and methods for describing unstructured or semi-structured documents in a collection to improve the effectiveness of search, the quality of human browsing, and the automation of information handling processes.

Extensible Structured Controlled Vocabularies

Extensible Structured Controlled Vocabularies (ESCVs) address the second deficit of SCVs, i.e., that extension of such vocabularies requires special skills, by enriching the set of relations used to connect terms to one another and by providing mechanisms which allow non-experts to extend the vocabulary.

In one embodiment, ESCVs organize terms by six relations:

1. generality relations

2. part/whole relations

3. categorization relations

4. purpose/dependency relations

5. sequencing relations

6. equivalence relations

The diversity of the relations serves multiple goals:

they provide more ways to distinguish different terms

they provide more ways to find similar terms

they encourage term creators to articulate distinguishing and common characteristics

These relations are used by search and browsing procedures to identify identical or related concepts. It is at least the case that these procedures treat equivalent terms identically. But such procedures can also use these relations to restrain or expand searches or browsing in particular ways, for instance based on geography, time, or implicit context.

The diversity of the possible relations between terms makes it feasible for non-experts to extend the vocabulary with reduced ambiguity relative to conventional vocabularies. One embodiment of the invention provides an interface, which automatically searches for related terms while a new term is being defined, enhancing the non-experts ability to extend the vocabulary. These related terms can be connected to and distinguished from the new term by the non-expert extender of the vocabulary.

In addition, the addition of a general-purpose equivalence relation (such as listed for the embodiment described above) allows post-hoc auditing of additions to erase any deleterious effects of inadvertently introduced idiosyncrasy. If two users of the system create terms with the same intent but different instantiations, linking them with an equivalence relation permits any search or browsing algorithms to use them interchangeably.

Fine-Grained in Two Ways

ESCVs allow description to be fine grained in two ways. First, it allows the introduction of fine-grained terms (for instance '401(K) plans' as a specialization of ‘retirement plans’) without leading to failed document retrievals. It also makes annotation less labor-intensive because it is only necessary to provide the most specific terms in the ESCV when annotating a document or document fragment.

The increased expressive specificity is especially critical when the descriptions become fine-grained in another way: annotating media resources at a “sub-document” level, such as the annotation of individual paragraphs or even clauses (or in the case of multimedia, image fragments or time segments). Terms that might be too precise to ever apply to an entire document (such as, in a legal environment, violations of a particular clause of a particular statute), may make perfect sense when applied to a single paragraph or statement.

### AN EXAMPLE

This section presents a brief example of the sort of fine-grained description and extensibility described in the previous section. We consider the particular case of text describing kinds of dogs. The text might be used in a specialized database or web site. The description starts by indicating the general species of domesticated dog that is connected by generalization relations to biological concept-terms such as vertebrate and mammal and also to social concept-terms such as pet and domesticated animal.

A straightforward extension of this vocabulary would introduce new concept-terms for the different kinds of dogs which have compound names in everyday language but are not distinct species or sub-species: German Shepherds, Labrador Retrievers, etc. Most ontologies start with just such naturally occurring terms.

Finer grained distinctions can be made by creating further specializations and adding distinguishing characteristics such as color or size (chocolate lab, toy poodle) or purposes (guide dogs, companion dogs, drug-sniffing dogs). By providing a rich language for both relation and differentiation, an ESCV supports the creation of new and more precise terms while also enabling search procedures to retrieve resources or fragments based on relations between terms.

For example, a dog fancier might specialize a concept-term such as “Labrador Retriever” into new concept-terms distinguished by different color shades (black, yellow, white, dark chocolate, light chocolate, copper, etc). A search procedure, however, might choose to ignore some of these differences based on the context of a particular query. By providing multiple relation types, an ESCV allows the creation of new terms that articulate particular differences but also allows search procedures to intelligently ignore some differences.

Automated Vocabulary Generation

The possibility of vocabulary extension by non-experts leads naturally to the question of automated and semi-automated extension of ESCVs. The present invention includes a method for automatically extending ESCVs based on a combination of statistical and linguistic analysis. This automatic process may be followed by a more labor-intensive “auditing process” where automatically generated terms are refined and interconnected by human experts or “semiexperts”.

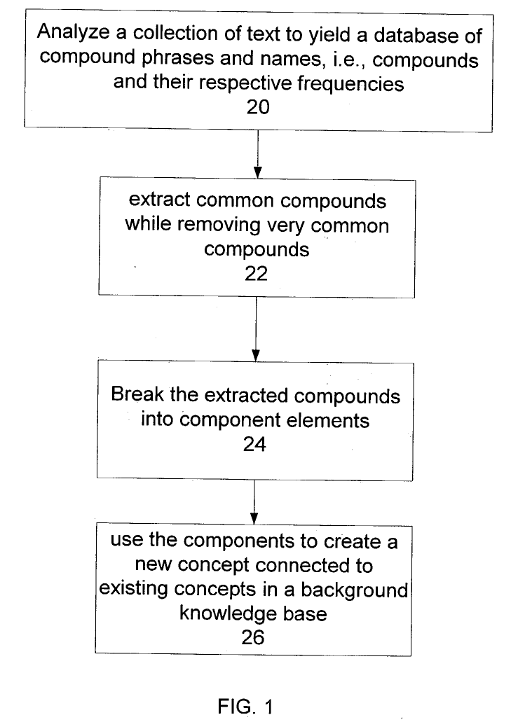

With reference to FIG. 1, the process of generating such extended vocabularies begins with a simple linguistic analysis 20 of a collection of text. It is the goal of this analysis to extract compound phrases and proper names, recording frequency information about these phrases and names. This extraction process is both language-specific and (to a lesser degree) genre-specific. This is due to the variations in grammar and morphology in different languages (for instance, some languages merge compounds into single words, while others conveniently separate the words by spaces) and to varying conventions for things like titles or affiliations. However, it can be accomplished with some generality, yielding a database of compounds, names, and their respective frequencies in the document collection. The generation process will also, of necessity, generate some “noise” in the form of word sequences that are not actual phrases or names.

Once this database has been generated, the system extracts 22 more common names and (if necessary) removes very common names. It is expected that many of the most common and rarest occurrences are the “noise” generated by erroneous phrase and name detection. It is also expected that the middle range of phrases and names is likely to contain the significant concepts occurring repeatedly in the corpus.

Once theses phrases and names are identified, more specific procedures, are applied. These are geared towards recognizing particular linguistic constructions or lexical conventions. For example, one such procedure might recognize an abbreviated title followed by person's full name, such as (“Dr. George Miller”), a name followed by an informative suffix (e.g. “Alma Media Oyj”), or a noun phrase indicating a part and whole of an artifact (e.g. “bottle cap”).

Each of these methods breaks 24 the compound into component elements and uses 26 this breakdown to create a new concept connected to existing concepts in the background knowledge base. For example, knowing that a “bottle” is a physical artifact, it could identify meanings for the word “cap” which applied to physical artifacts (excluding the abstract meanings in phrases like “sales cap”). Knowing that “George” is typically a masculine name, it could make an assumption about the individual's gender; knowing that “Dr.” indicates a level of education, it could make that information explicit as well. In some cases, such inferences are extremely reliable: “Alma Media Oyj” reliably refers to a publicly traded Finnish company, based on the suffix “Oyj”, just as “beingmeta, inc.” refers to a formally incorporated business.

In addition, the specialized analysis allows the generation of alternate names for the concept. In particular, some elements of a recognized name can conventionally be dropped; e.g. we can refer to “Dr. George Miller” as simply “George Miller”. This generation process may actually use the structure of the knowledge base to create concepts for both names and to connect them using a relationship such as generalization or equivalence.

In performing this automatic generation, it is important to consider (and limit) the scope of the document collection being analyzed. For example, on the whole World Wide Web, there are probably hundreds of “George Miller”s and dozens of “Dr. George Miller”s. If the background knowledge base is to correctly identify individuals, it is important to apply this method to smaller collections where ambiguities are unlikely to occur or to use other methods (clustering based on context, for instance) to artificially subdivide the collection.

The potential for error also indicates the value of human auditing of the generated knowledge base. This auditing can include correction of erroneous assumptions (a boy named “Sue”) the splitting of different individuals erroneously identified as one (“George W. Bush” and “George H. W. Bush”), and the connection of different concepts created for the same individual (e.g. “Hilary Rodham” and “Hilary Clinton”).

ESCVs constitute a useful solution to the fine-grained description of document collections. Embodiments of the invention use a diversity of relations between terms in an ESCV to enhance search and other forms of information access. Embodiments of the invention also articulate methods for extending a structured controlled vocabulary, which enable non-experts (i.e. individuals who are not linguists or semanticians) to extend the vocabulary.

ESCVs work by articulating parts of the rich web of human meanings and using that articulation to support search, browsing, and automated processing of documents.

Having thus described at least one illustrative embodiment of the invention, various alterations, modifications and improvements are contemplated by the invention. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. A method for managing a user-extensible structured controlled vocabulary, the method comprising:
receiving new term data from a user; and
allowing the user to associate the new term data with related concepts by allowing the user to use a plurality of relations including an equivalence relation.

2. The method of claim 1 wherein allowing the user to associate the new term data comprises allowing the user to use a generality relation, a part/whole relation, a categorization relation, a purpose/dependency relation, and a sequencing relation.
